(19) United States
(12) Patent Application Publication
(10) Pub. No.: US 2001/0012361 A1
(43) Pub. Date: Aug. 9, 2001

(54) Encryption method, decryption method, cryptographic communication method and cryptographic communication system

(75) Inventor: Masao Kasahara, Mino-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 09/767,753

(22) Filed: Jan. 23, 2001

(30) Foreign Application Priority Data
Jan. 25, 2000 (JP) 2000-16357
Mar. 15, 2000 (JP) 2000-73033

(51) Int. Cl. H04L 9/30

(52) U.S. Cl. 380/30; 380/37; 380/277

(57) ABSTRACT

Divided plaintexts, secret keys, public keys, random numbers, and the like are expressed in a polynomial representation, whereby a product-sum type cryptosystem is constituted on a finite field, whereby the cryptosystem is made resistive to attacks by LLL algorithm than a product-sum type cryptosystem on an integer ring. Divided plaintexts are encoded, and each term of the intermediate decrypted text is constituted of an error correcting code word, whereby the original plaintext is reproduced by the correction capability of the code word even when an error occurs.

### BACKGROUND OF THE INVENTION

The present invention relates to an encryption method of the public-key cryptosystem for encrypting a plaintext into a ciphertext using a public key, a decryption method of decrypting a ciphertext generated by the encryption method into a plaintext, a cryptographic communication method and a cryptographic communication system using these encryption method and decryption method, and a memory product/data signal embodied in carrier wave for recording/transmitting an operation program of the encryption method.

In the modern society, called a highly information-oriented society, based on a computer network, important business documents and image information are transmitted and communicated in a form of electronic information. Such electronic information can be easily copied, so that it tends to be difficult to discriminate its copy and original from each other, thus bringing about an important issue of data integrity. In particular, it is indispensable for establishment of a highly information oriented society to implement such a computer network that meets the factors of “sharing of computer resources,” “multi-accessing,” and “globalization,” which however includes various factors contradicting the problem of data integrity among the parties concerned. In an attempt to eliminate those contradictions, encrypting technologies which have been mainly used in the past military and diplomatic fields in the human history are attracting world attention as an effective method for that purpose.

A cipher communication is defined as exchanging information in such a manner that no one other than the parties concerned can understand the meaning of the information. In the field of the cipher communication, encryption is defined as converting an original text (plaintext) that can be understood by anyone into a text (ciphertext) that cannot be understood by the third party and decryption is defined as restoring a ciphertext into a plaintext, and cryptosystem is defined as the overall processes covering both encryption and decryption. The encrypting and decrypting processes use secret information called an encryption key and a decryption key, respectively. Since the secret decryption key is necessary in decryption, only those knowing this decryption key can decrypt ciphertexts, thus maintaining data security.

The encryption scheme is roughly classified into two types: common-key cryptosystem and public-key cryptosystem. In a common-key cryptosystem, an encryption key and a decryption key are identical with each other, and a sender and a recipient perform cryptographic communications by possessing an identical common key. The sender encrypts a plaintext based on a secret common key and transmits the resultant ciphertext to the recipient, and then the recipient decrypts the ciphertext into the original plaintext by using this common key.

On the other hand, in a public-key cryptosystem, an encryption key and a decryption key are different from each other, and cryptographic communications are performed by encrypting a plaintext by the sender with the use of a publicized public key of the recipient and decrypting the resultant ciphertext by the recipient with the use of its own secret key. The public key is a key used for encryption and the secret key is a key used for decrypting the ciphertext transformed by the public key, and the ciphertext transformed by the public key can be decrypted only by the secret key.

As a scheme of public-key cryptosystem, a product-sum type cryptoscheme has been known. In this cryptosystem, an entity of sender generates a ciphertext C=m₁c₁+m₂c₂+ . . . +m_{K}c_{K} by using both a plaintext vector m=(m₁, m₂, . . . , m_{K}) obtained by dividing a plaintext into K parts and a base vector c=(c₁, C₂, . . . , c_{K}) as public key. The other entity of recipient decrypts the ciphertext C into the plaintext vector m by using a secret key thereby to obtain the original plaintext. Prior art product-sum type cryptoschemes use an operation on an integer ring.

With regard to such a product-sum type cryptography, various new cryptoschemes have been proposed and investigated from the viewpoint of security improvement, process time speedup, and the like.

Nevertheless, such a product-sum type cryptography, by nature, has a feature of being easily attacked by using a mathematical LLL (Lenstra-Lenstra-Lovasz) algorithm which decrypts each component of a plaintext vector m from each component of a base vector c made public. Thus, the development of a product-sum type encryption method resistive to attacks by the LLL algorithm has been desired.

### BRIEF SUMMARY OF THE INVENTION

An object of the present invention is to provide a product-sum type encryption method of new scheme resistive to attacks by LLL algorithm because of constituting a cryptosystem on a finite field, thereby improving the security.

Another object of the present invention is to provide a decryption method of decrypting a ciphertext generated by the above-mentioned encryption method into a plaintext, a cryptographic communication method and a cryptographic communication system using the above-mentioned encryption method and decryption method, and a memory product/data signal embodied in carrier wave for recording/transmitting an operation program of the encryption method.

In a first aspect of the present invention, secret keys, public keys, random numbers, and the like are expressed in a polynomial representation, whereby a product-sum type cryptosystem is constituted on a finite field instead of an integer ring. As a result, the cryptosystem is more resistive to attacks by LLL algorithm than a product-sum type cryptosystem on an integer ring, thereby improving the security.

In a second aspect of the present invention, each term of intermediate decrypted text is constituted of an error correcting code word, whereby the original plaintext can be reproduced accurately by the correction capability of the code word even if an error of a certain extent occurs.

In a third aspect of the present invention, a plurality of public keys are previously prepared for each of divided plaintexts obtained by dividing a plaintext. For each of the divided plaintexts, an arbitrary public key is selected from among the prepared plurality of public keys, whereby a ciphertext is generated by using the selected public keys. As such, public keys are selective, that is, an entity of sender can arbitrarily select the public keys to generate a ciphertext. Accordingly, the manner of the public key selection is unknown to attackers, which makes attacks difficult thereby to improve the security further.

The above and further objects and features of the present invention will more fully be apparent from the following detailed description with accompanying drawings.

### BRIEF DESCRIPTION OF THE SEVERAL VIEWS OF THE DRAWINGS

FIG. 1 is a schematic diagram showing a situation of informational communication between two entities in accordance with a first embodiment;

FIG. 2 is a diagram showing a public key list in a database of a first example of the first embodiment;

FIG. 3 is a diagram showing a public key list in a database of a second example of the first embodiment;

FIG. 4 is a schematic diagram showing a situation of informational communication between two entities in accordance with a second embodiment; and

FIG. 5 is a diagram showing the configuration of an embodiment of a memory product.

### DETAILED DESCRIPTION OF THE INVENTION

The embodiments of the present invention are described below in detail.

First, the polynomial representation in the present invention is explained. The m shown in the following (1) represents a message generated by encoding a plaintext M for the purpose of class -selection information in the first embodiment described later or error correction detection in the second embodiment described later. Here, K is the number of division of the plaintext M.

m=(m₁, m₂, . . . , m_{K}) (1)

Although each component mᵢ(i=1, 2, . . . , K) of the message m is a kᵢ-dimensional vector on a finite field (Galois field) F_{q}, an assumption is made herein such that q=2 and kᵢ=k (constant), for the simplicity of description.

As such, the message m is previously encoded. In order to emphasize this fact, each component mᵢ of the message m is rewritten into mᵢ′, and the mᵢ′ is expressed by the following (2) with mᵢⱼ′εF₂. Further, the component mᵢ is expressed by the following (3) in a polynomial representation.

$$\begin{matrix}{m}_{i}^{′} = ( {m}_{{i}_{1}}^{′} , {m}_{{i}_{2}}^{′} , … , {m}_{ik}^{′} ) & ( 2 ) \\ {m}_{i}^{′} ( X ) = {m}_{{i}_{1}}^{′} + {m}_{{i}_{2}}^{′} X + … + {m}_{ik}^{′} {X}^{k - 1} & ( 3 )\end{matrix}$$

Meanwhile, a value A is expressed by a vector s or a polynomial s(X) herein, and the vector s and the polynomial s(X) are referred to as a vector representation and a polynomial representation of A, respectively.

First embodiment: Arbitrary selection of public keys in a product-sum type cryptosystem on a finite field

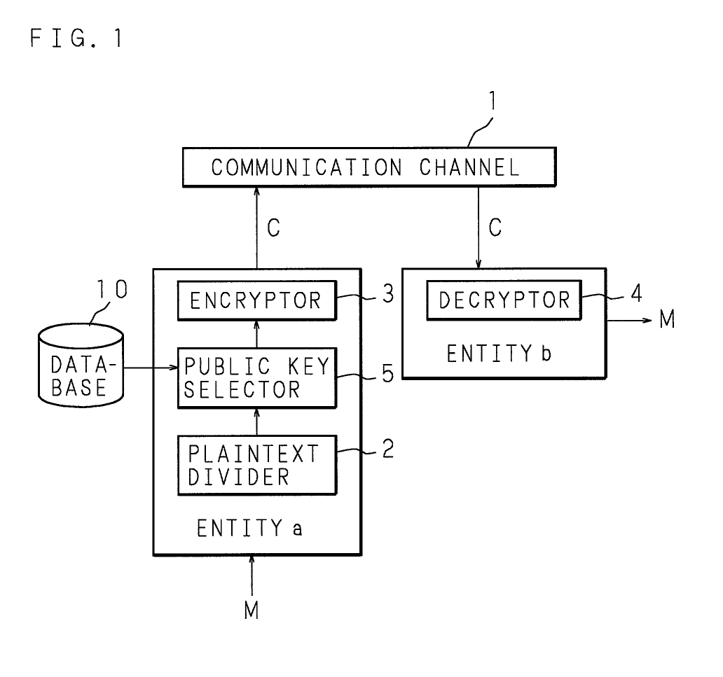

FIG. 1 is a schematic diagram showing a situation that an encryption method/decryption method in accordance with the first embodiment is used in an informational communication between two entities a, b. In the example of FIG. 1, an entity a encrypts a plaintext M into a ciphertext C, thereby transmitting the ciphertext C through a communication channel 1 to the other entity b. The entity b decrypts the ciphertext C into the original plaintext M.

The entity a of sender comprises: a plaintext divider 2 for dividing a plaintext M into a plurality of divided plaintexts; a public key selector 5 for selecting a public key for each divided plaintext from a database 10; and an encryptor 3 for generating a ciphertext C using the selected public keys and divided plaintexts. On the other hand, the entity b of recipient comprises a decryptor 4 for decrypting the transmitted ciphertext C into the original plaintext M. In the first embodiment, secret keys, public keys, random numbers, and the like are expressed in a polynomial representation as described later, whereby a product-sum type cryptosystem is constituted on a finite field.

First example of the first embodiment

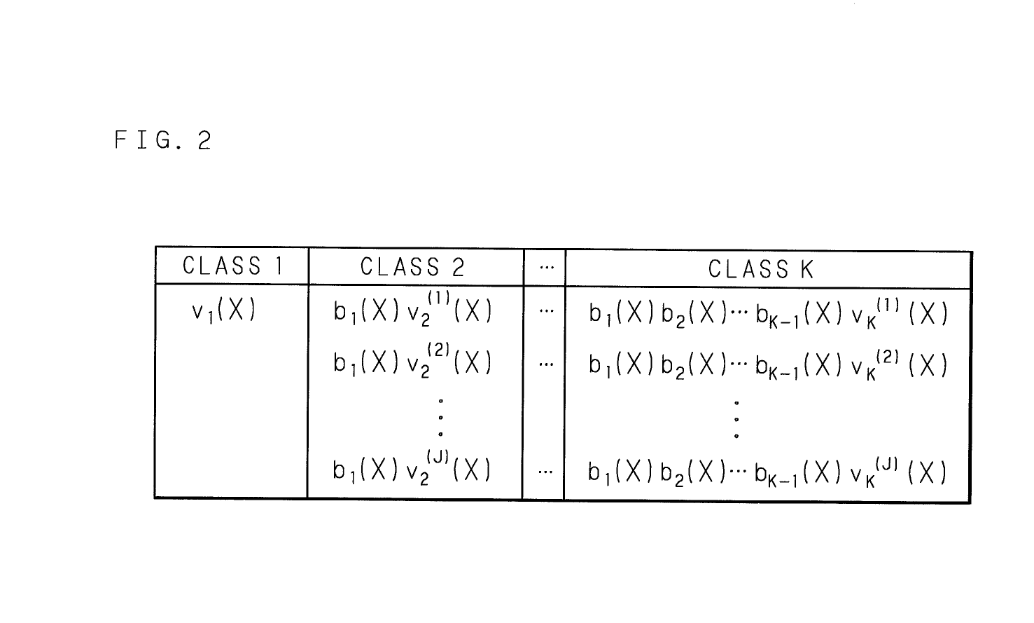

FIG. 2 is a diagram showing a public key list (base list) in the database 10 previously storing a plurality of public keys for each divided plaintext. In FIG. 2, K is the number of division (number of classes) of a plaintext M, and J is the total number of the public keys (bases) of selection objectives for each class i (i=1, 2, . . . , K). J public keys (bases) are prepared for each divided plaintext (each class) except for the class 1.

The entity a of sender arbitrarily selects and reads out a key (base) for each divided plaintext (each class) from the database 10 storing such public keys (bases), and then uses the read-out K public keys (bases) as encryption keys. Here, the number of the possible selection combinations of public keys (bases) allowed for the entity a is J^{K-1}. The existence of the J^{K-1} combinations of public keys (bases) provides grounds for the further security of the first embodiment, in addition to the constitution on a finite field.

Preparation

Some symbols are defined as follows.

mᵢ: component of message m; mᵢεF_{q} (q=2^{k})

αᵢ, βᵢ: random numbers; αᵢ, βᵢεF_{q}

vᵢ: random number vector on F_{q} belonging to class i of public key list

bᵢ: base bᵢ=αᵢ+βᵢX

Encryption

Secret keys and public keys are prepared as follows.

Secret keys: {bᵢ(X)}, {vᵢ(X)}, w(X), P(X), permutation matrix P(*)

Public keys: {cᵢ^{(j)}(X)}, F_{q}

With P(X) being an appropriately selected, secret irreducible polynomial, the following (4) is deduced.

$${b}_{1} ( X ) {b}_{2} ( X ) … {b}_{i} ( X ) {v}_{i + 1}^{( j )} ( X ) w ( X ) ≡ {c}_{i}^{( j )} ( X ) ( mod P ( X ) ) \qquad ( 4 )$$

The polynomial representation b₁(X) b₂(X) . . . bᵢ₋₁(X) vᵢ(X) of the plurality of public keys of selection objectives shown in FIG. 2 corresponds to a vector representation b₁ b₂ . . . bᵢ₋₁ vᵢ.

Encryption is carried out on F_{q} as shown in the following (5).

$$C ( X ) = {\sum }_{i = 1}^{K} {m}_{i}^{′} {c}_{i}^{( j )} ( X ) \qquad ( 5 )$$

Decryption

By using a secret polynomial w⁻¹(X) satisfying the following (6), an intermediate decrypted text M(X)≡C(X) w⁻¹ (X) (mod P(X)) is deduced as shown in the following (7) with i≦j≦J.

w(X)w⁻¹(X)≡1 (mod P(X)) (6)

$$\begin{matrix}C ( X ) {w}^{- 1} ( X ) ≡ {m}_{1}^{′} {v}_{1} ( X ) + {m}_{2}^{′} {b}_{1} ( X ) {v}_{2}^{( j )} ( X ) + … + \\ {m}_{k}^{′} {b}_{1} ( X ) {b}_{2} ( X ) … {b}_{K - 1} ( X ) {v}_{k}^{( j )} ( X ) ( mod P ( X ) )\end{matrix} \qquad ( 7 )$$

After the lowest order term m₁′v₁(X) of the intermediate decrypted text M(X) is decrypted, the subsequent terms can be decrypted similarly.

By using the inverse element v₁⁻¹(X) of v₁ (X) modulo b₁ (X), the following (8) is deduced. Here, as shown in FIG. 2, the base (v₁(X)) is uniquely selected in the class 1.

M(X)v₁(X)v₁⁻¹(X)≡m₁′(mod b₁(X)) (8)

The encoded component m₁ of the original plaintext is decoded from m₁′, and the selection information of base (public key) in the class 2 is decrypted according to the following (9).

m₁′≡j (mod J) (9)

Thus, the selected base (public key b₁(X) v₂^{(j)} (X)) in the class 2 is specified, therefore, m₂′ can be decrypted in the same manner as that for m₁′. That is, the m₂′ is decrypted according to the following (10). The m₃′ to m_{K}′ are decrypted similarly.

$$\begin{matrix}\frac{M ( X ) - {m}_{1}^{′} {v}_{1} ( X )}{{b}_{1} ( X )} = {m}_{2}^{′} {v}_{2}^{( j )} ( X ) + {m}_{3}^{′} {b}_{2} ( X ) {v}_{3}^{( j )} ( X ) + … + \\ {m}_{k}^{′} {b}_{2} ( X ) … {b}_{K - 1} ( X ) {v}_{K}^{( j )} ( X )\end{matrix} \qquad ( 10 )$$

As such, the description of the first example has been made for the case that the lowest order term of message of a product-sum type ciphertext is first decrypted and that the higher order terms of message are then sequentially decrypted. However, the process may be reversed such that the highest order term of message is first decrypted and that the lower order terms of message are then sequentially decrypted.

Second example of the first embodiment

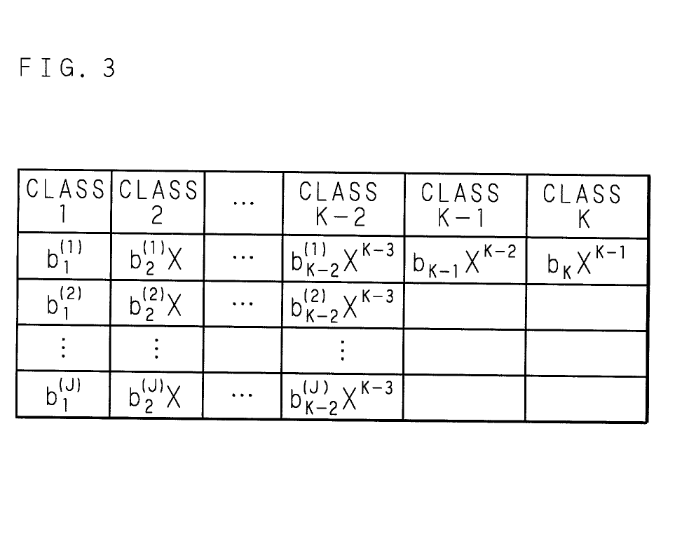

FIG. 3 is a diagram showing a public key list (base list) in the database 10 previously storing a plurality of public keys for each divided plaintext. In FIG. 3, K is the number of division (number of classes) of a plaintext M, and J is the total number of the public keys (bases) of selection objectives for each class i (i=1, 2, . . . , K−2). J public keys (bases) are prepared for each divided plaintext (each class) except for the (K−1)-th and the K-th class.

The entity a of sender arbitrarily selects and reads out a key (base) for each divided plaintext (each class) from the database 10 storing such public keys (bases), and then uses the read-out K public keys (bases) as encryption keys. Here, the number of the possible selection combinations of public keys (bases) allowed for the entity a is J^{K-2}.

Preparation

Some symbols are defined as follows.

mᵢ′: component of message m; mᵢ′≡F_{q}(q=2^{k})

αᵢ^{(j)}, βᵢ^{(j)}: random numbers; αᵢ^{(j)}, βᵢ^{(j)}≡F_{q}

bᵢ: base bᵢ^{(j)}(X)=αᵢ^{(j)}+βᵢ^{(j)}X

Encryption

Secret keys and public keys are prepared as follows.

Secret keys: {bᵢ(X)}, w(X), P(X), permutation matrix P(*)

Public keys: {cᵢ^{(j)}(X)}, F_{q}

With P(X) being an appropriately selected, secret irreducible polynomial, the following (11) is deduced.

$${b}_{i}^{( j )} ( X ) w ( X ) {X}^{i - 1} ≡ {c}_{i}^{( j )} ( X ) ( mod P ( X ) ) \qquad ( 11 )$$

Here, the components of vector cᵢ^{(j)} are randomly located by the secret permutation matrix P(*). In FIG. 3, a vector representation of bᵢ^{(j)}(X) is expressed by bᵢ^{(j)}. The reason why only one base is used in the classes K−1, K as described above in FIG. 3 is to achieve a high-speed decryption as described later.

Encryption is carried out on F_{q} as shown in the following (12).

$$C ( X ) = {\sum }_{i = 1}^{K} {m}_{i}^{′} {c}_{i}^{( j )} ( X ) \qquad ( 12 )$$

Decryption

By using a secret polynomial w⁻¹(X) satisfying the following (13), an intermediate decrypted text M(X)≡C(X) w⁻¹ (X) (mod P(X)) is deduced as shown in the following (14) with i≦j≦J.

w(X)w⁻¹(X)≡1 (mod P(X)) (13)

$$\begin{matrix}C ( X ) {w}^{- 1} ( X ) ≡ {m}_{1}^{′} {b}_{1}^{( j )} ( X ) + {m}_{2}^{′} {b}_{2}^{( j )} ( X ) X + … + \\ {m}_{k}^{′} {b}_{k} ( X ) {X}^{K - 1} ( mod P ( X ) )\end{matrix} \qquad ( 14 )$$

When the highest order term m_{K}′ of the intermediate decrypted text M(X) is decrypted, the second highest order term m_{K-1}′ to the lowest order term m₁′ can be decrypted similarly. Thus, the description herein is made below by focusing on the decryption of m_{K}′.

Let Sⁱ (M) generally indicate the operation of sampling the 2k digits corresponding to the bases bᵢ₋₁^{(j)}, bᵢ^{(j)} of a vector M, and let the sampled series be expressed by a polynomial S_{M}ⁱ(X). The series S_{M}^{K}(X) generated by sampling the highest 2k digits of the intermediate decrypted text M(X) given by equation (14) is obtained by the following (15). Here, e_{K-1} (X) is a polynomial representation of the highest k digits of the second highest term m_{K-1}′(X) b_{K-1} (X).

S_{M}^{K}(X)=m_{K}′(X)b_{K}(X)+e_{K-1}(X) (15)|

The above-mentioned e_{K-1} (X) is generally called a postfix. The e_{K-1} (X) can be deduced according to the following (16), whereby the message m_{K}′(X) can be decrypted according to the following (17).

$$\begin{matrix}{S}_{M}^{K} ( X ) ≡ {e}_{K - 1} ( X ) ( mod {b}_{k} ( X ) ) & ( 16 ) \\ \frac{{S}_{M}^{K} ( X ) - {e}_{K - 1} ( X )}{{b}_{K} ( X )} = {m}_{K}^{′} ( X ) & ( 17 )\end{matrix}$$

As shown in FIG. 3, there is no room for selection in the classes K−1, K, then the b_{K-1}, b_{K} are uniquely selected in respective classes. While the original information m_{K} is decrypted from m_{K}′, the selection information of base in the class K−2 is decrypted according to the following (18). More generally, the selection information of base in the class i−2 is obtained using mᵢ′≡j (mod J).

m_{K}′≡j (mod J) (18)

As such, the base selection information of the second next class is decrypted. The purpose of this is to prepare the base bᵢ₋₂^{(j)} before entering the encryption of S_{M}ⁱ⁻²(M) given for the class i−2. As a result, the decryption process can be sequentially performed without delay.

The form of the base b_{K-2}^{(j)} in the class K−2 is specified according to m_{K}′≡j (mod J), therefore, m_{K-2}′ can be decrypted in the same manner as that for m_{K}′. Further, by rewriting m_{K-1}′ as shown in the following (19), the m_{K-1}′ can be decrypted in the same manner as that for m_{K}′. The m₁′ to m_{K-2}′ can be decrypted sequentially in descending order by the similar process.

M^{K-1}(X)=M^{K}(X)+m_{K}′(X)b_{K}(X)X^{K-1} (19)

In the above-mentioned first example, the decryption process of message and the decryption process of base selection information can not be performed in parallel. In contrast, in the second example, the base selection information of class i−2 can be obtained during the decryption of the i-th message, that is, the decryption process of message and the decryption process of base selection information can be performed in parallel. More specifically, the operation of the above-mentioned (16) in the i-th class and the operation of the above-mentioned (17) in the (i−1)-th class can be performed in parallel. This is what is called a pipeline processing, which permits a much higher-speed decryption processing in the second example than in the first example.

The description of the second example has been made for the case that the highest order term of message of a product-sum type ciphertext is first decrypted and that the lower order terms of message are then sequentially decrypted. However, the process may-be reversed such that the lowest order term of message is first decrypted and that the higher order terms of message are then sequentially decrypted.

Next, the security in the first embodiment described above is explained. The j-th public key cᵢ^{(j)}(X) in the class i is expressed by the following (20).

$${c}_{i}^{( j )} ( X ) = {c}_{{i}_{1}}^{( j )} + {c}_{{i}_{2}}^{( j )} X + … + {c}_{{i}_{K}}^{( j )} {X}^{K - 1} \qquad ( 20 )$$

Observing that the message mᵢ in the class i is involved into a product independently of each coefficient of the polynomial expressed by the above-mentioned (20), the vector (cᵢ₁^{(j)}, cᵢ₂^{(j)}, . . . , c_{iK}^{(j)}) on F_{q} corresponding to the coefficient of the polynomial of the above-mentioned (20) can be randomly scrambled in an appropriate order known to the recipient alone but by a permutation common to each class. Thus, the designer can save the permutation matrix P(*) as a secret key. Accordingly, number-theoretical attacks to the public information is practically impossible for K≧30 or so. For example, in the case that k=16 for the k in F_{q} with q=2^{k} and that K=32, the total number of trials necessary to obtain the correct order is appropriately 2.6×10³⁵.

Let a vector representation of a ciphertext C be the following (21), where each component thereof is set as the following (22).

$$\begin{matrix}C = ( {C}_{1} , {C}_{2} , … , {C}_{K} ) & ( 21 ) \\ {C}_{i} = {\sum }_{t = 1}^{K} {m}_{i} {c}_{it}^{( j )} & ( 22 )\end{matrix}$$

Here, observing that Cᵢ, mᵢ, cᵢₜ^{(j)}εF_{q}, an attack by LLL algorithm is difficult to apply to the above-mentioned (22). Here, J≧2 is necessary because, otherwise, the above-mentioned (22) is decrypted self-evidently by a simple linear transformation. The number of the random selections of public keys is J^{K-1} (first example) and J^{K-2} (second example); thus, J^{K-1}>>1 and J^{K-2}>>1 are possible. Accordingly, an attack to a public-key cryptography in accordance with the first embodiment can be carried out only one by one; therefore, this encryption/decryption method is very powerful.

Meanwhile, the public key size and the encryption key size of each entity in accordance with the first embodiment are given as follows.

public key size: J K²k bits

encryption key size of each entity: K² k bits

Since the message has been encoded at the beginning of a cryptographic communication, the following condition (23) is required according to the above-mentioned conditions (9), (18), and hence, the rate (information transmission rate) becomes less than 1.

J<2^{k} (23)

However, in case that the selected keys are fixed during a predetermined time duration or during the data transmission of a predetermined amount of data, the above-mentioned condition (23) is unnecessary, and hence, the rate becomes approximately 1.

Specific numerical examples are described below.

### Numerical Example 1

In a rather large-scale case of k=16, K=1024, and J=1024, the public key size is 2¹⁰·2²⁰·2⁴=2³⁴ bits≈2.147 Gbytes, and the encryption key size of each entity is 2.0 kbytes.

### Numerical Example 2

In a rather small-scale case of k=8, K=128, and J=128, the public key size is 2.097 Mbytes, and the encryption key size of each entity is 16.384 kbytes.

### Numerical Example 3

In case of k=16, K=128, and J=128, the public key size is 4.19 Mbytes, and the encryption key size of each entity is 32.8 kbytes. The principal operation for encryption is a product-sum operation of 128 elements of F_{q} (q=2¹⁶) (for example, carried out in seven steps by a 128 parallel processing). The principal operations for decryption are a multiplicative and divisional operation of a polynomial of degree 128 on F_{q} (q=2¹⁶) and 128 successive multiplicative and divisional operations of a polynomial of degree one on F_{q} (q=2¹⁶).

### Numerical Example 4

In case of k=8, K=32, and J=16, the public key size is 16.4 kbytes, and the encryption key size of each entity is 1.02 kbytes. The principal operation for encryption is a product-sum operation of 32 elements of F_{q} (q=2⁸) (for example, carried out in five steps by a 32 parallel processing). The principal operations for decryption are a multiplicative and divisional operation of a polynomial of degree 32 on F_{q} (q=2⁸) and 32 successive multiplicative and divisional operations of a polynomial of degree one on F_{q} (q=2⁸).

The rate and the improvement thereof in the second example are described below. Since the degree of the secret polynomial P(X) is K+1, input plaintext length L_{M} and output ciphertext length L_{C} are given by the following (24) and (25), respectively, and further, rate r is given by the following (26).

L_{M}=Kk (24)

L_{C}=(K+1)k (25)

r=K/(K+1) (26)

Let us consider a condition necessary for the rate r to be completely 1. Assume that the bases b₁^{(j)} in the class 1 are all constant terms alone, that is, b₁^{(j)}=α₁^{(j)}. In this case, the following (27) is assumed to be satisfied. Further, vector P(wᵢ^{(j)}, w₂^{(j)}, . . . , w_{K}^{(j)}) is deduced by randomly permutating the components of the coefficient vector (wᵢ^{(j)}, w₂^{(j)}, . . . , w_{K}^{(j)}), and designated to subkeys of the class 1 of the public key list.

$${α}_{1}^{( j )} w ( X ) = {w}_{1}^{( j )} + {w}_{2}^{( j )} X + {w}_{3}^{( j )} {X}^{2} + … + {w}_{k}^{( j )} {X}^{K - 1} \qquad ( 27 )$$

Even in this case, as long as K>>1, a trial-and-error attack to the P(w₁^{(j)}, w₂^{(j)}, . . . , w_{K}^{(j)}) is still practically impossible.

Therefore, input plaintext length L_{M}, output ciphertext length L_{C}, and rate r are given by the following (28), (29), and (30), respectively.

$$\begin{matrix}{L}_{M} = Kk & ( 28 ) \\ {L}_{C} = Kk & ( 29 ) \\ r = 1 & ( 30 )\end{matrix}$$

Second embodiment: A product-sum type cryptography using error correcting code on a finite field

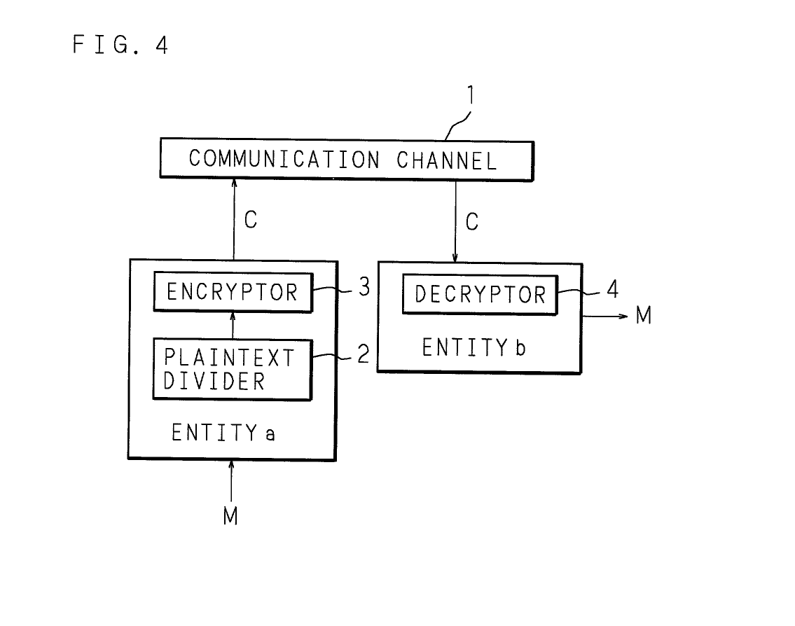

FIG. 4 is a schematic diagram showing a situation that an encryption method/decryption method in accordance with the second embodiment is used in an informational communication between two entities a, b. Similarly to the FIG. 1, also in the example of FIG. 4, an entity a encrypts a plaintext M into a ciphertext C, thereby transmitting the ciphertext C through a communication channel 1 to the other entity b. The entity b decrypts the ciphertext C into the original plaintext M.

The entity a of sender comprises: a plaintext divider 2 for dividing a plaintext M into a plurality of divided plaintexts; and an encryptor 3 for generating a ciphertext C using public keys and divided plaintexts. On the other hand, the entity b of recipient comprises a decryptor 4 for decrypting the transmitted ciphertext C into the original plaintext M. In the second embodiment, similarly to the first embodiment, secret keys, public keys, random numbers, and the like are expressed in a polynomial representation, whereby a product-sum type cryptosystem is constituted on a finite field.

Encryption

Secret keys and public keys are prepared as follows.

Secret keys: {X^{a}gᵢ(X)}, w(X), P(X)

Public keys: {Cᵢ (X)}, encoding parameters for m

Let a code polynomial on F₂ of degree gᵢ be gᵢ(X). However, gᵢ=g (constant) is assumed herein for the simplicity of description. With P(X) being an appropriately selected, secret polynomial, the following (31) is deduced. Here, aᵢ=a (constant) is assumed similarly to the above-mentioned gᵢ.

X^{a}^{ᵢ}gᵢ(X)w(X)≡Cᵢ(X) (mod P(X)) (31)

Encryption is carried out as shown in the following (32).

$$C ( X ) = {\sum }_{i = 1}^{K} {m}_{i}^{′} ( X ) {C}_{i} ( X ) \qquad ( 32 )$$

Decryption

First decryption example of the second embodiment

By using a secret polynomial w⁻¹(X) satisfying the following (33), an intermediate decrypted text M(X) is deduced as shown in the following (34). More specifically, the intermediate decrypted text M(X) is obtained as shown in the following (35).

$$\begin{matrix}w ( X ) {w}^{- 1} ( X ) ≡ 1 ( mod P ( X ) ) & ( 33 ) \\ M ( X ) ≡ C ( X ) {w}^{- 1} ( X ) ( mod P ( X ) ) & ( 34 ) \\ \begin{matrix}M ( X ) = {g}_{1} ( X ) {m}_{1}^{′} ( X ) + {g}_{2} ( X ) {m}_{2}^{′} ( X ) {X}^{a} + … + \\ {g}_{k} ( X ) {m}_{K}^{′} ( X ) {X}^{( K - 1 ) a}\end{matrix} & ( 35 )\end{matrix}$$

In the above, the degree p of the secret polynomial P(X) is set to be larger by 1 than the degree of the right-hand side of the above-mentioned (35). Then, p satisfies the following condition (36).

p=g+k+(K−1)a+1 (36)

Let Sₐ(w) indicate the operation of sampling the lowest n digits of the vector w, and let the sampled series be expressed by a polynomial S_{w}(X). Then, the following (a), (b) hold.

(a): In a series S_{w}(X) sampled from the intermediate decrypted text M(X) given by the above-mentioned (35), when a<g+k=n, the end e₁(X) of length (g+k−a) of the second term is in an additional form as shown in the following (37).

g₁(X)m₁(X)+e₁(X)X^{a} (37)

(b): Let the degree of the end e₁(X) be (e−1). Then, in case that g≧e, the e₁(X) is correctable as a disappearance error.

According to (a), (b), the e₁(X) X^{a} in S_{w}(X) can be corrected as a disappearance error. Therefore, g₁(X) m₁(X) can be decrypted, whereby m₁(X) can be easily decrypted. That is, each term of the intermediate decrypted text has a form of product-sum component plus noise component. However, since the product-sum component is an error correcting code word, the noise component can be corrected as an error by the error correction capability thereof, whereby the product-sum component can be decrypted purely and accurately. The subsequent terms can be decrypted similarly to the first term. As such, in the first decryption example, decryption is performed sequentially from the lowest order term in ascending order.

Second decryption example of the second embodiment

By using a secret polynomial w⁻¹(X) satisfying the following (38), an intermediate decrypted text M(X) is deduced as shown in the following (39). More specifically, the intermediate decrypted text M(X) is obtained as shown in the following (40).

$$\begin{matrix}w ( X ) {w}^{- 1} ( X ) ≡ 1 ( mod P ( X ) ) & ( 38 ) \\ M ( X ) ≡ C ( X ) {w}^{- 1} ( X ) ( mod P ( X ) ) & ( 39 ) \\ \begin{matrix}M ( X ) = {g}_{1} ( X ) {m}_{1}^{′} ( X ) + {g}_{2} ( X ) {m}_{2}^{′} ( X ) {X}^{a} + … + \\ {g}_{K} ( X ) {m}_{K}^{′} ( X ) {X}^{( K - 1 ) a}\end{matrix} & ( 40 )\end{matrix}$$

The following (c), (d) hold.

(c): In a series S_{w}(X) sampled from the intermediate decrypted text M(X) given by the above-mentioned (40), when a<g+k=n, the e_{K-1}(X) of the higher order (g+k−a) digits of the second term g_{K-1}(X) m_{K}_{K-1}′(X) is in an additional form as shown in the following (41).

g_{K}(X)m_{K}′(X)+e_{K-1}(X)Xₐ (41)

(d): Let the degree of the e_{K-1} (X) be (e−1). Then, in case that g≧e, the e_{K-1}(X) is correctable as a disappearance error.

According to (c), (d), the e_{K-1}(X) in S_{w}(X) can be corrected as a disappearance error. Therefore, g_{K}(X) m_{K}′ (X) can be decrypted, whereby m_{K}′ (X) can be easily decrypted. As such, in the second decryption example, decryption is performed sequentially from the highest order term in descending order.

Meanwhile, in this second embodiment, similarly to the above-mentioned first embodiment, a scheme can be used such that public keys are arbitrarily selected. When such a scheme is applied to the first example of the first embodiment, let gᵢ(X) belong to a class i; J pieces of gᵢ(X) are prepared for each class except for the class 1; m₁ is decoded from the m₁(X) decrypted in the class 1; and the public key selection information in the class 2 can be obtained similarly. When such a scheme is applied to the second example of the first embodiment, let gᵢ(X) belong to a class i; J pieces of gᵢ(X) are prepared for each class except for the classes K, K−1; m_{K} is decoded from the m_{K}(X) decrypted in the class K; and the public key selection information in the class K−2 can be obtained similarly.

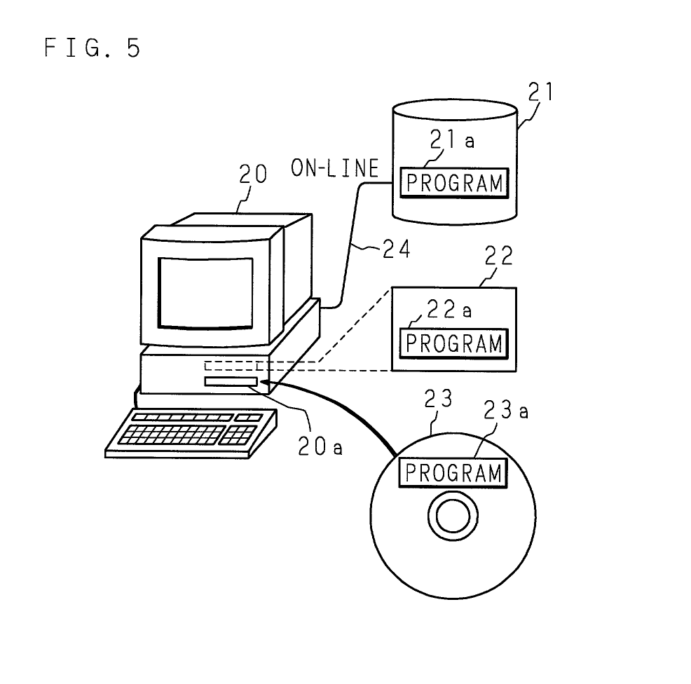

FIG. 5 is a diagram showing the configuration of an embodiment of a memory product in accordance with the present invention. The program illustrated here contains an encryption process or a decryption process in accordance with the first embodiment or the second embodiment described above, and further is recorded in a memory product described below. A computer 20 is provided in each entity.

In FIG. 5, a memory product 21 is composed of, for example, a server computer on the WWW (World Wide Web) installed apart from the installed location of the computer 20. In the memory product 21, a program 21a described above is recorded. The program 21a read out from the memory product 21 via a transmission medium 24 such as a communication line controls the computer 20 so as to generate a ciphertext from a plaintext or decrypt a ciphertext into a plaintext.

A memory product 22 provided in the interior of the computer 20 is composed of a disk drive, a ROM, or the like built in. In the memory product 22, a program 22a described above is recorded. The program 22a read out from the memory product 22 controls the computer 20 so as to generate a ciphertext from a plaintext or decrypt a ciphertext into a plaintext.

A memory product 23 used in the loaded state into a disk drive 20a provided in the computer 20 is composed of a magneto-optical disk, a CD-ROM, a flexible disk, or the like portable. In the memory product 23, a program 23a described above is recorded. The program 23a read out from the memory product 23 controls the computer 20 so as to generate a ciphertext from a plaintext or decrypt a ciphertext into a plaintext.

As described above, in the present invention, since a product-sum type cryptosystem is constituted on a finite field, the cryptosystem is more resistive to attacks by LLL algorithm than a product-sum type cryptosystem on an integer ring, thereby improving the security.

Further, each term of the intermediate decrypted texts is constituted of an error correcting code word, whereby the original plaintext can be reproduced accurately by the correction capability of the code word even if an error of a certain extent occurs.

Furthermore, a plurality of public keys are previously prepared for each of divided plaintexts generated by dividing a plaintext. For each of the divided plaintexts, an arbitrary public key is selected from among the prepared plurality of public keys, whereby a ciphertext is generated by using the selected public keys. As a result, one can arbitrarily select the public keys to generate a ciphertext. Accordingly, the manner of the public key selection is unknown to attackers, which makes attacks difficult thereby to improve the security further.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalent of such metes and bounds thereof are therefore intended to me embraced by the claims.

1. An encryption method, comprising the steps of:
dividing a plaintext to be encrypted into a plurality of divided plaintexts; and
generating a product-sum type ciphertext constituted on a finite field by using the divided plaintexts and public keys.

2. The encryption method of claim 1, wherein
said divided plaintexts are encoded, whereby each term of the intermediate decrypted text is constituted of an error correcting code word.

3. The encryption method of claim 1, wherein:
a plurality of public keys are previously prepared for each of the divided plaintexts; and for each divided plaintext, an arbitrary public key is selected from among the prepared plurality of public keys, whereby a ciphertext is generated by using the selected public keys.

4. The encryption method of claim 3, wherein
the public key is fixed for a predetermined number of divided plaintexts.

5. The encryption method of claim 4, wherein
the predetermined number is one or two.

6. The encryption method of claim 3, wherein
a ciphertext is generated such that selection information for indicating the public key selected for one divided plaintext is involved in another divided plaintext apart from the divided plaintext by a predetermined number.

7. The encryption method of claim 6, wherein
the predetermined number is one or two.

8. A decryption method of decrypting a product-sum type ciphertext generated in accordance with the encryption method of claim 1, wherein the decryption of divided plaintexts is performed sequentially starting from the lowest order term of the divided plaintexts of the ciphertext in ascending order.

9. A decryption method of decrypting a product-sum type ciphertext generated in accordance with the encryption method of claim 1, wherein the decryption of divided plaintexts is performed sequentially starting from the highest order term of the divided plaintexts of the ciphertext in descending order.

10. A decryption method of decrypting a product-sum type ciphertext generated in accordance with the encryption method of claim 6, wherein the decryption process of a divided plaintext and the decryption process of selection information are carried out in parallel.

11. A cryptographic communication method for communicating information between a first entity and a second entity by using a ciphertext, comprising the steps of:
at the first entity, dividing a plaintext to be encrypted into a plurality of divided plaintexts;
at the first entity, generating a product-sum type ciphertext constituted on a finite field by using the divided plaintexts and public keys;
at the first entity, transmitting the generated ciphertext to the second entity; and
at the second entity, decrypting the transmitted ciphertext into a plaintext.

12. A cryptographic communication system for communicating information between plurality of entities by using a ciphertext, comprising:
an encryptor for generating a ciphertext from a plaintext in accordance with the encryption method of claim 1;
a communication channel for transmitting the generated ciphertext from one entity to another entity; and
a decryptor for decrypting the transmitted ciphertext into a plaintext.

13. A computer memory product having computer readable program code means for causing a computer to generate a ciphertext, said computer readable program code means comprising:
program code means for causing the computer to divide a plaintext to be encrypted into a plurality of divided plaintexts; and
program code means for causing the computer to generate a product-sum type ciphertext constituted on a finite field by using the divided plaintexts and public keys.

14. A computer data signal embodied in a carrier wave for transmitting a program, the program being configured to cause a computer to generate a ciphertext, comprising:
a code segment for causing the computer to divide a plaintext to be encrypted into a plurality of divided plaintexts; and
a code segment for causing the computer to generate a product-sum type ciphertext constituted on a finite field by using the divided plaintexts and public keys.
